(19) United States
(12) Patent Application Publication
(10) Pub. No.: US 2026/0080280 A1
(43) Pub. Date: Mar. 19, 2026

(54) INFORMATION PROCESSING APPARATUS, INFORMATION PROCESSING METHOD, AND NON-TRANSITORY COMPUTER-READABLE RECORDING MEDIUM

(71) Applicant: LY Corporation, Tokyo (JP)

(72) Inventor: Takayuki YAMAMOTO, Tokyo (JP)

(21) Appl. No.: 19/222,196

(22) Filed: May 29, 2025

(30) Foreign Application Priority Data
Sep. 19, 2024 (JP) 2024-162191

(51) Int. Cl. G06N 5/04

(52) U.S. Cl. CPC G06N 5/04

(57) ABSTRACT

An information processing apparatus according to the present application includes a change unit and a generation unit. The change unit changes, based on a predetermined change policy, a sparse feature value obtained by converting a feature value output by a predetermined layer in a learning model when predetermined input information is input to the learning model learned to generate, as output information, an answer to a question input as input information, the sparse feature value indicating a generation policy for the learning model to generate output information corresponding to the predetermined input information. The generation unit causes the learning model to generate output information corresponding to the predetermined input information using a feature value obtained by converting the changed sparse feature value changed by the change unit as a feature value output by the predetermined layer in the learning model.

### CROSS-REFERENCE TO RELATED APPLICATIONS

The present application claims priority to and incorporates by reference the entire contents of Japanese Patent Application No. 2024-162191 filed in Japan on Sep. 19, 2024.

### BACKGROUND OF THE INVENTION

### 1. Field of the Invention

The present invention relates to an information processing apparatus, an information processing method, and an information processing program.

### 2. Description of the Related Art

In recent years, researches and developments using a large language model (LLM) have been actively conducted. For example, a technique for operating an answer output from the LLM to a desired answer is known (see “Scaling Monosemanticity: Extracting Interpretable Features from Claude 3 Sonnet”, Adly Templeton, et al. <Internet> https://transformer-circuits.pub/2024/scaling-monosemanticity/(Searched on Jul. 30, 2024)).

However, since the application range of the related art is limited, for example, suitable output information based on a predetermined change policy sometimes cannot be generated.

### SUMMARY OF THE INVENTION

It is an object of the present invention to at least partially solve the problems in the conventional technology.

According to an example of a subject matter described in a present disclosure, an information processing apparatus includes a change unit configured to change, based on a predetermined change policy, a sparse feature value obtained by converting a feature value output by a predetermined layer in a learning model when predetermined input information is input to the learning model learned to generate, as output information, an answer to a question input as input information, the sparse feature value indicating a generation policy for the learning model to generate output information corresponding to the predetermined input information and a generation unit configured to cause the learning model to generate output information corresponding to the predetermined input information using a feature value obtained by converting the changed sparse feature value changed by the change unit as a feature value output by the predetermined layer in the learning model.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of learning processing executed by an information processing apparatus according to an embodiment;

FIG. 2 is a diagram illustrating an example of generation processing executed by the information processing apparatus according to the embodiment;

FIG. 3 is a diagram illustrating an example of determination processing executed by the information processing apparatus according to the embodiment;

FIG. 4 is a diagram illustrating an example of learning processing executed by the information processing apparatus according to the embodiment;

FIG. 5 is a diagram illustrating a configuration example of an information processing system according to the embodiment;

FIG. 6 is a diagram illustrating an example of a learning data storage unit according to the embodiment;

FIG. 7 is a diagram illustrating an example of a content provision information storage unit according to the embodiment;

FIG. 8 is a diagram illustrating an example of a user information storage unit according to the embodiment;

FIG. 9 is a diagram illustrating an example of a correction value information storage unit according to the embodiment;

FIG. 10 is a diagram illustrating an example of an evaluation information storage unit according to the embodiment;

FIG. 11 is a conceptual diagram of generation processing according to the embodiment;

FIG. 12 is a flowchart illustrating an example of a flow of learning processing executed by the information processing apparatus according to the embodiment;

FIG. 13 is a flowchart illustrating an example of a flow of generation processing executed by the information processing apparatus according to the embodiment;

FIG. 14 is a flowchart illustrating an example of a flow of determination processing executed by the information processing apparatus according to the embodiment;

FIG. 15 is a flowchart illustrating an example of a flow of learning processing executed by the information processing apparatus according to the embodiment;

FIG. 16 is a conceptual diagram of generation processing according to a modification; and

FIG. 17 is a hardware configuration diagram illustrating an example of a computer that implements the functions of the information processing apparatus.

### DETAILED DESCRIPTION OF THE PREFERRED EMBODIMENTS

Hereinafter, a mode (hereinafter referred to as “embodiment”) for implementing an information processing apparatus, an information processing method, and an information processing program according to the present application is explained in detail with reference to the drawings. Note that the information processing apparatus, the information processing method, and the information processing program according to the present application are not limited by the embodiment. Embodiments can be combined as appropriate within a range in which processing contents do not contradict one another. In the following embodiments, the same parts are denoted by the same reference numerals and signs and redundant explanation of the parts is omitted.

### 1. Example of Information Processing Executed by the Information Processing Apparatus

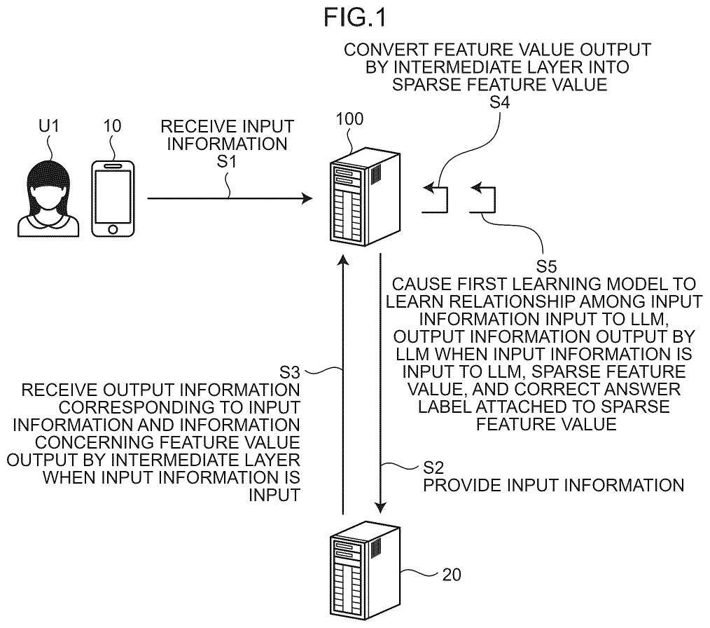

First, the premise is explained. In examples in FIGS. 1 to 4 explained below, it is assumed that an information processing apparatus 100 provides a service (an example of a predetermined service) for providing an advertisement (an example of content) to a user U1. In this case, for example, the user U1 is assumed to receive the provision of the advertisement on a portal site including a search service provided by the information processing apparatus 100. The portal site is provided by the information processing apparatus 100.

For example, a predetermined frame arranged at a predetermined position in the portal site and having a predetermined size includes a region for receiving input information such as character information input by the user U1 and a region for displaying output information such as character information with respect to the input information.

The output information referred to here is provided by generative AI such as text generation AI (Artificial Intelligence) that generates text. For example, the text generation AI is an LLM learned to estimate the next token from an input token sequence and output the next token. For example, the LLM is a transformer based model, a recurrent neural network (RNN) based model, or the like. For example, the LLM is a model learned to output an answer sentence corresponding to an input question sentence and is a language model that performs natural language processing such as a GPT (Generative Pre-trained Transformer) or a Transformer. Note that the LLM may be present in the information processing apparatus 100 and created independently by a business operator that manages the information processing apparatus 100. An LLM in which information such as input personal information is concealed by learning such that input information is not used as a new answer is desirable.

For example, the user U1 creates, as input information, a prompt including character information serving as a question on the predetermined frame. Then, the information processing apparatus 100 transmits such a prompt to a generative AI server 20 that provides output information using the generative AI. In this case, the information processing apparatus 100 cooperates with the generative AI server 20 to provide, on the predetermined frame, output information serving as an answer to the input information and including an advertisement.

Note that the advertisement arranged in the output information may be arranged in any manner. For example, the advertisement may be arranged for a predetermined period in a predetermined period of time.

Based on the above premise, respective kinds of information processing executed by the information processing apparatus 100 are explained below with reference to FIGS. 1 to 4.

### 1-1. Example of Learning Processing Executed by the Information Processing Apparatus

First, learning processing executed by the information processing apparatus 100 is explained with reference to FIG. 1. FIG. 1 is a diagram illustrating an example of the learning processing executed by the information processing apparatus according to the embodiment. Hereinafter, first, processing in which the information processing apparatus 100 stores a learning data set is explained. Next, processing in which the information processing apparatus 100 causes a first learning model to learn the learning data set is explained.

First, the processing in which the information processing apparatus 100 stores the learning data set is explained with reference to FIG. 1. In the example illustrated in FIG. 1, the information processing apparatus 100 receives input information from a user terminal 10 used by the user U1 (Step S1). For example, it is assumed that the user U1 inputs character information as input information. In this case, the information processing apparatus 100 receives the character information as the input information.

Subsequently, the information processing apparatus 100 provides the input information to the generative AI server 20 (Step S2). In this case, the generative AI server 20 generates output information corresponding to the input information.

Then, when the input information is input, the information processing apparatus 100 receives the output information corresponding to the input information and receives information concerning a feature value output by an intermediate layer of the LLM, which is as an example of a predetermined layer in the LLM (Step S3).

Subsequently, the information processing apparatus 100 converts the feature value output by the intermediate layer into a sparse feature value (Step S4). Note that such conversion processing can be implemented by using a technology based on a sparse autoencoder (SAE) using deep learning.

In this case, the information processing apparatus 100 stores the input information, the output information, the converted sparse feature value, and a correct answer label attached to the sparse feature value in a predetermined storage unit in association with one another. As explained above, the information processing apparatus 100 stores, as the learning data set, in the predetermined storage unit, information in which the input information, the output information, the sparse feature value, and the correct answer label are associated with one another.

Here, the correct answer label is attached based on the output information. The correct answer label may be attached manually or automatically. A unit of attaching the correct answer label may be, for example, for each sparse feature value. The unit of attaching the correct answer label may be, for example, for each node constituting the sparse feature value.

Next, processing in which the information processing apparatus 100 causes the first learning model to learn the learning data set is explained with reference to FIG. 1. In the example illustrated in FIG. 1, the information processing apparatus 100 causes the first learning model to learn a relationship among the input information input to the LLM, the output information output by the LLM when the input information is input to the LLM, the sparse feature value, and the correct answer label attached to the sparse feature value (Step S5). That is, the information processing apparatus 100 causes the first learning model to learn the learning data set stored in the predetermined storage unit. Here, the first learning model is a learning model called SAE.

The sparse feature value indicates a generation policy for the LLM to generate output information corresponding to predetermined input information. For example, the sparse feature value is expressed with a meaning inside the LLM as a vector. More specifically, the sparse feature value indicates a sparse feature value in which one dimension among dimensions of the vector indicated by the sparse feature value indicates the information relating to the advertisement. In this case, one node constituting the sparse feature value indicates an advertisement, an appealing target of the advertisement, a characteristic of the appealing target of the advertisement, the quality of the appealing target of the advertisement, impression of the user on the appealing target of the advertisement, and the like. For example, one node constituting the sparse feature value indicates a character, a symbol, a word, a sentence, a statement, a paragraph, or the like.

As explained above, by causing the first learning model to learn a relationship among the input information input to the LLM, the output information output by the LLM when the input information is input to the LLM, the sparse feature value, and the correct answer label attached to the sparse feature value, the information processing apparatus 100 can generate a learning model for generating suitable output information.

Note that the learning processing of the first learning model may not be limited to the embodiment explained above. For example, it is assumed that information in which input information and output information for the input information are associated with each other is stored in advance in the predetermined storage unit. In this case, the information processing apparatus 100 causes the LLM to generate the output information corresponding to the input information by providing the input information to the generative AI server 20. The information processing apparatus 100 converts a feature value output by the intermediate layer at the time of the input to the LLM into a sparse feature value. Then, the information processing apparatus 100 converts the sparse feature value into a feature value.

Subsequently, the information processing apparatus 100 performs learning to cause the LLM to generate output information corresponding to the input information using the feature value as the feature value output by the intermediate layer. Accordingly, the information processing apparatus 100 can perform learning to make the feature value output by the intermediate layer sparse.

Then, the information processing apparatus 100 specifies a correspondence relationship between content indicated by the output information and nodes of the sparse feature value. As explained above, the information processing apparatus 100 can specify which node has a high or low value when what kind of output information is output. Accordingly, the information processing apparatus 100 can cause the LLM to estimate a relationship between the nodes and the correct answer label.

### 1-2. Example of Generation Processing Executed by the Information Processing Apparatus

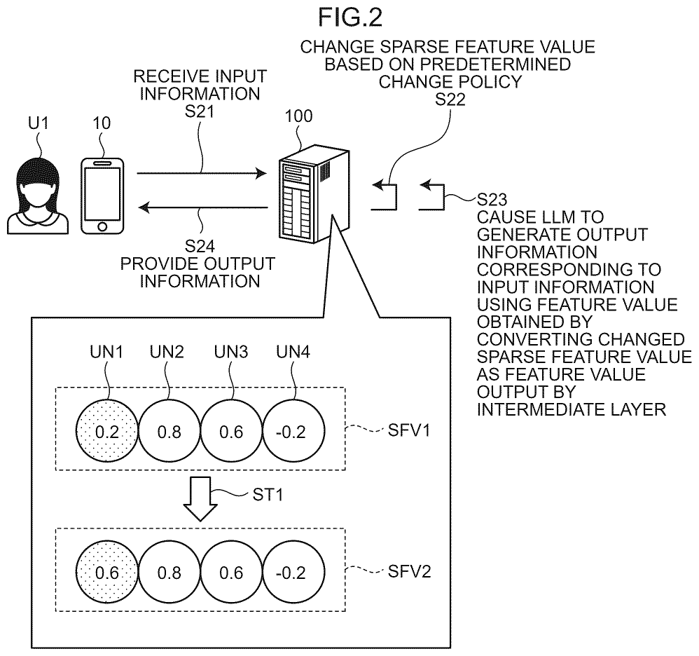

Next, generation processing executed by the information processing apparatus 100 is explained with reference to FIG. 2. FIG. 2 is a diagram illustrating an example of generation processing executed by the information processing apparatus according to the embodiment. Hereinafter, an example is explained in which the information processing apparatus 100 changes the sparse feature value based on a predetermined change policy set in advance and causes the LLM to generate output information using, as a feature value output by the intermediate layer, a feature value obtained by converting the changed sparse feature value.

In the example illustrated in FIG. 2, a company A is explained as an example of a content provider that provides content in the predetermined service. For example, it is assumed that the company A submits an advertisement of an automobile product of the company A to a business operator that manages the information processing apparatus 100.

In the example illustrated in FIG. 2, the information processing apparatus 100 receives input information from the user terminal 10 (Step S21). For example, it is assumed that the user U1 inputs, as the input information, character information indicating content concerning the automobile product. In this case, the information processing apparatus 100 receives, as the input information, character information indicating the content concerning the automobile product from the user terminal 10.

Subsequently, the information processing apparatus 100 changes the sparse feature value based on a predetermined change policy (Step S22). The sparse feature value referred to herein is obtained by converting the feature value output by the intermediate layer.

In the example illustrated in FIG. 2, amount sparse feature value SFV1 includes four nodes UN1 to UN4. For example, it is assumed that the output information is output information including content for appealing to an automobile. In this case, the node UN1 is a node indicating a reference to the automobile product of the company A. The node UN2 is a node indicating a reference to an automobile product of a competitor of the company A. The node UN3 is a node indicating a pleasant feeling for the automobile. The node UN4 is a node indicating quality reliability. In the example illustrated in FIG. 2, the node UN1 indicates “0.2”. The node UN2 indicates “0.8”. The node UN3 indicates “0.6”. The node UN4 indicates “−0.2”.

Here, it is assumed that the predetermined change policy is set in advance by the company A. For example, the predetermined change policy is a change policy of increasing a ratio of the reference to the automobile product of the company A in the output information when the output information includes the reference to the automobile product of the competitor. In this case, to increase the ratio of the reference to the automobile product of the company A in the output information, a value of the node UN1 corresponding to the reference is increased.

That is, the information processing apparatus 100 changes the value of the node UN1 when changing the sparse feature value based on the predetermined change policy (Step ST1). For example, the information processing apparatus 100 changes the sparse feature value based on a correction value based on the predetermined change policy and the sparse feature value. Accordingly, the information processing apparatus 100 changes the sparse feature value SFV1 to a sparse feature value SFV2. In the sparse feature value SFV2, the node UN1 indicates “0.6”. In the sparse feature value SFV2, the node UN2 indicates “0.8”. In the sparse feature value SFV2, the node UN3 indicates “0.6”. In the sparse feature value SFV2, the node UN4 indicates “−0.2”.

Then, the information processing apparatus 100 causes the LLM to generate output information corresponding to the input information using, as a feature value output by the intermediate layer, a feature value obtained by converting the changed sparse feature value (Step S23). For example, the information processing apparatus 100 generates, as the output information, output information including character information in which the reference to the automobile product of the competitor and the reference to the automobile product of the company A are included at the same ratio. The information processing apparatus 100 generates output information including the advertisement of the automobile product of the company A.

Subsequently, the information processing apparatus 100 provides the output information to the user terminal 10 (Step S24). For example, the information processing apparatus 100 provides, to the user terminal 10, as the output information, character information including the reference to the automobile product of the competitor and the reference to the automobile product of the company A at the same ratio and output information including the advertisement of the automobile product of the company A.

As explained above, the information processing apparatus 100 can generate suitable output information based on the predetermined change policy by causing the LLM to generate the output information corresponding to the input information using, as the feature value output by the intermediate layer, the feature value obtained by converting the changed sparse feature value.

### 1-3. Example of Determination Processing Executed by the Information Processing Apparatus

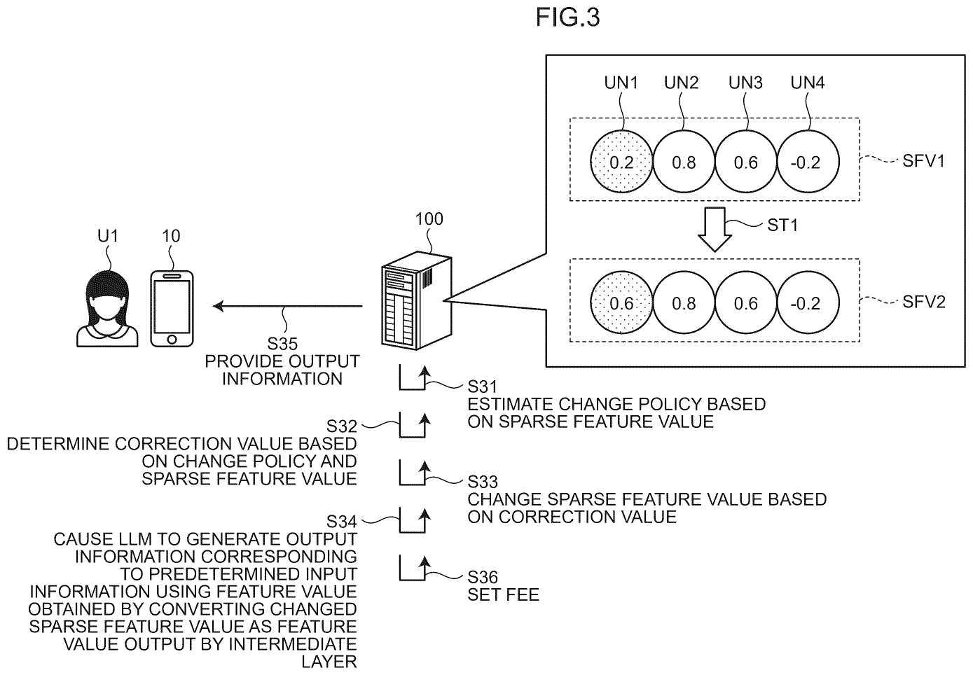

Next, determination processing executed by the information processing apparatus 100 is explained with reference to FIG. 3. FIG. 3 is a diagram illustrating an example of determination processing executed by the information processing apparatus according to the embodiment.

In the example illustrated in FIG. 3, the information processing apparatus 100 estimates a change policy based on the sparse feature value (Step S31). For example, it is assumed that the output information output by the LLM includes the reference to the automobile product of the competitor. In this case, the information processing apparatus 100 estimates a change policy of increasing a rate of the reference to the automobile product of the company A in the output information based on a sparse feature value obtained by converting a feature value output by the intermediate layer.

Subsequently, the information processing apparatus 100 determines a correction value based on the change policy and the sparse feature value (Step S32). Since the sparse feature value SFV1 illustrated in FIG. 3 is the same as the sparse feature value SFV1 illustrated in FIG. 2, detailed explanation of the sparse feature value SFV1 is omitted.

In the example illustrated in FIG. 3, in the sparse feature value SFV1, the node UN1 indicates “0.2”. In the sparse feature value SFV1, the node UN2 indicates “0.8”. In the sparse feature value SFV1, the node UN3 indicates “0.6”. In the sparse feature value SFV1, the node UN4 indicates “−0.2”.

For example, to increase the ratio of reference to the own automobile product in the output information, the information processing apparatus 100 determines a correction value for increasing a value of the node UN1 corresponding to the reference. For example, the information processing apparatus 100 determines a transformation matrix such as the following Expression (1) as the correction value based on the number of dimensions of a vector indicated by the sparse feature value SFV1.

$$A = ( \begin{matrix}1 & k & 0 & 0 \\ 0 & 1 & 0 & 0 \\ 0 & 0 & 1 & 0 \\ 0 & 0 & 0 & 1\end{matrix} ) \qquad ( 1 )$$

k is a value set based on a degree of changing the sparse feature value. A value of a node is changed by changing the value of k. For example, it is assumed that k is 0.5.

The information processing apparatus 100 changes the sparse feature value based on the correction value (Step S33). The information processing apparatus 100 changes the sparse feature value SFV1 to the sparse feature value SFV2 by multiplying the sparse feature value SFV1 by the Expression (1).

In this case, the node UN1 indicates “0.6” in the sparse feature value SFV2. In the sparse feature value SFV2, the node UN2 indicates “0.8”. In the sparse feature value SFV2, the node UN3 indicates “0.6”. In the sparse feature value SFV2, the node UN4 indicates “−0.2”.

Subsequently, the information processing apparatus 100 causes the LLM to generate output information corresponding to the predetermined input information using, as a feature value output by the intermediate layer, a feature value obtained by converting the changed sparse feature value (Step S34). For example, the information processing apparatus 100 converts the changed sparse feature value into a feature value. Then, the information processing apparatus 100 causes the LLM to generate output information corresponding to the input information using the converted feature value as the feature value output by the intermediate layer.

For example, the information processing apparatus 100 generates, as the output information, output information including character information in which the reference to the automobile product of the competitor and the reference to the automobile product of the company A are included at the same ratio. The information processing apparatus 100 generates output information including the advertisement of the automobile product of the company A.

Then, the information processing apparatus 100 provides the output information to the user terminal 10 (Step S35). For example, the information processing apparatus 100 provides, to the user terminal 10, as the output information, character information including the reference to the automobile product of the competitor and the reference to the automobile product of the company A at the same ratio and output information including the advertisement of the automobile product of the company A.

Subsequently, the information processing apparatus 100 sets a fee based on the correction value for the company A (Step S36). In this case, the information processing apparatus 100 executes settlement processing for the company A at the fee. For example, the information processing apparatus 100 cooperates with a predetermined settlement server to execute the settlement processing for the fee for the company A.

More specifically, the information processing apparatus 100 executes the settlement processing at a fee for the predetermined settlement server every time or every predetermined period (for example, one month). Accordingly, the information processing apparatus 100 executes the settlement processing for the company A at the fee based on the correction value.

As explained above, the information processing apparatus 100 can estimate the suitable change policy for generating the desired output information. Accordingly, when the output information satisfies the predetermined condition, the information processing apparatus 100 can generate appropriate output information based on the estimated change policy.

### 1-4. Example of Learning Processing Executed by the Information Processing Apparatus

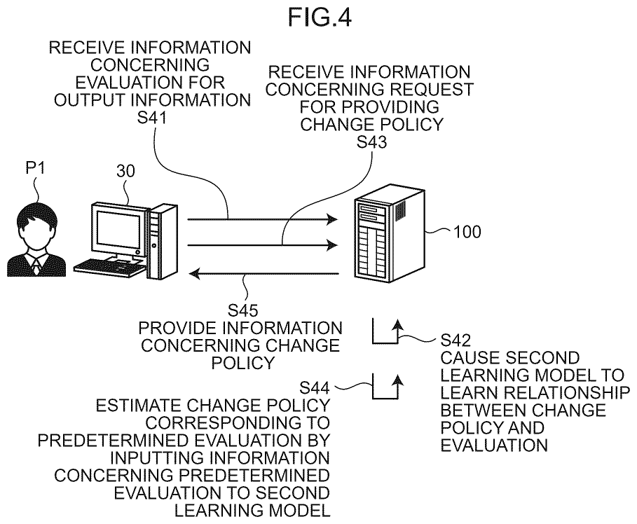

Next, learning processing executed by the information processing apparatus 100 is explained with reference to FIG. 4. FIG. 4 is a diagram illustrating an example of learning processing executed by the information processing apparatus according to the embodiment. Hereinafter, first, processing in which the information processing apparatus 100 generates a second learning model is explained. Next, processing in which the information processing apparatus 100 provides a change policy is explained.

First, processing in which the information processing apparatus 100 generates the second learning model is explained with reference to FIG. 4. In the example illustrated in FIG. 4, as an example of a content provider, a business operator P1 of the company A is explained.

It is assumed that, as the output information, character information including the reference to the automobile product of the competitor and the reference to the automobile product of the company A at the same ratio and output information including the advertisement of then automobile product of the company A is provided to the user U1. It is assumed that a change policy in the case of generating such output information is a change policy of increasing a ratio of the reference to the automobile product of the company A in the output information when the output information includes the reference to the automobile product of the competitor.

In the example illustrated in FIG. 4, the information processing apparatus 100 receives information concerning evaluation for the output information provided to the user U1 from a content provider terminal 30 used by the business operator P1 (Step S41). For example, it is assumed that the evaluation is five-grade evaluation. It is assumed that the evaluation of the output information is 5. In this case, the information processing apparatus 100 receives information indicating that the evaluation is 5 from the content provider terminal 30 as the evaluation for the output information.

Subsequently, the information processing apparatus 100 causes the second learning model to learn a relationship between the change policy in the case in which the output information is generated and the evaluation (Step S42). For example, the information processing apparatus 100 causes the second learning model to learn a relationship between the change policy of increasing the ratio of the reference to the automobile product of the company A in the output information in the case in which the output information includes the reference to the automobile product of the competitor and the evaluation 5. As explained above, when the information concerning the predetermined evaluation is input to the second learning model, the information processing apparatus 100 generates the second learning model that outputs the change policy corresponding to the predetermined evaluation.

Next, processing in which the information processing apparatus 100 provides a change policy is explained with reference to FIG. 4. In the example illustrated in FIG. 4, the information processing apparatus 100 receives information concerning a change policy provision request from the content provider terminal 30 (Step S43).

Subsequently, the information processing apparatus 100 inputs the information concerning the predetermined evaluation to the second learning model to estimate a change policy corresponding to the predetermined evaluation (Step S44). For example, the information processing apparatus 100 estimates a change policy corresponding to the evaluation 5 as the information concerning the predetermined evaluation. More specifically, the information processing apparatus 100 estimates a change policy that the output information includes only reference to the automobile product of the company A as the change policy corresponding to the evaluation 5.

Then, the information processing apparatus 100 provides information concerning the change policy (Step S45). For example, the information processing apparatus 100 provides, as the change policy, information concerning the change policy corresponding to the evaluation 5. More specifically, as a change policy corresponding to the evaluation 5, the information processing apparatus 100 provides information concerning a change policy that the output information includes only the reference to the automobile product of the company A.

As explained above, the information processing apparatus 100 can execute learning processing suitable for the predetermined service. For example, the information processing apparatus 100 causes the second learning model to learn a relationship between the change policy and the evaluation received by the content provider. Subsequently, the information processing apparatus 100 inputs the information concerning the predetermined evaluation to the second learning model to estimate the change policy corresponding to the predetermined evaluation. Then, the information processing apparatus 100 provides the estimated change policy to the content provider. Accordingly, the information processing apparatus 100 can provide the information concerning the suitable change policy to the content provider.

In the embodiment explained above, an example in which the evaluation is the five-grade evaluation is explained. However, the evaluation is not limited to this. For example, the evaluation may be N-grade evaluation (N is any number).

### 2. Configuration of an Information Processing System

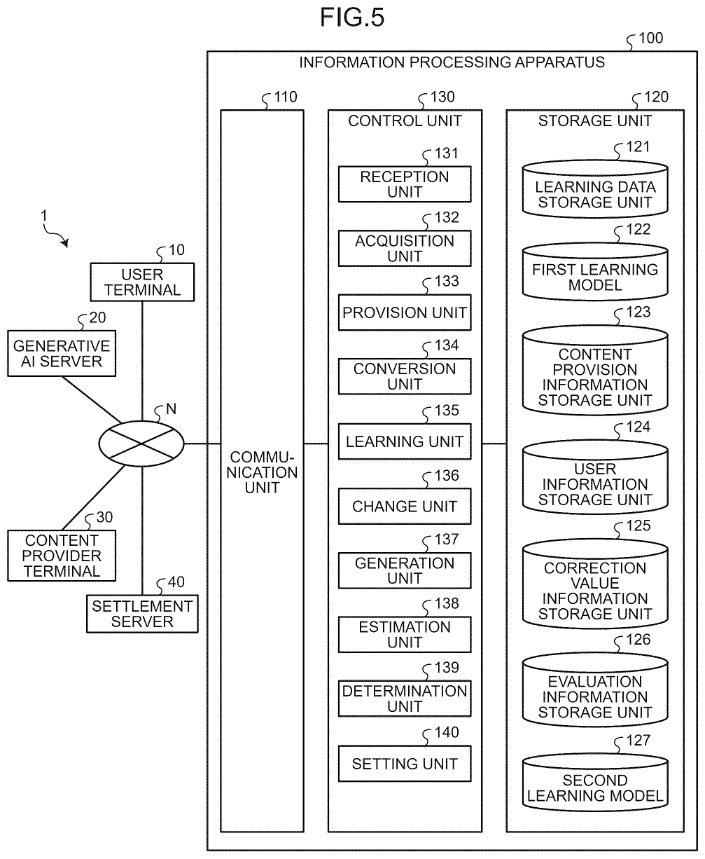

Next, a configuration of an information processing system 1 according to the embodiment is explained with reference to FIG. 5. FIG. 5 is a diagram illustrating a configuration example of the information processing system 1 according to the embodiment. As illustrated in FIG. 5, the information processing system 1 includes the user terminal 10, the generative AI server 20, the content provider terminal 30, a settlement server 40, and the information processing apparatus 100. The user terminal 10, the generative AI server 20, the content provider terminal 30, the settlement server 40, and the information processing apparatus 100 are communicably connected by wire or radio via a network N.

Note that the information processing system 1 illustrated in FIG. 5 may include a plurality of user terminals 10, a plurality of generative AI servers 20, a plurality of content provider terminals 30, a plurality of settlement servers 40, and a plurality of information processing apparatuses 100.

The user terminal 10 is an information processing apparatus used by a user who accesses content such as a web page or application content displayed on a browser. For example, the user terminal 10 is a desktop personal computer (PC), a notebook PC, a tablet terminal, a mobile phone, a personal digital assistant (PDA), or the like.

The generative AI server 20 is an information processing apparatus that receives input information and provides answer information corresponding to the input information as output information and is implemented by, for example, a server apparatus, a cloud system, or the like.

For example, the generative AI is text generation AI that generates a text. The text generation AI is, for example, a large-scale language model learned to estimate and output the next token from an input token sequence. For example, the large-scale language model is a transformer-based model, an RNN-based model, or the like.

The transformer-based model is, for example, a Generative Pre-trained Transformer (GPT), a Bidirectional Encoder Representations from Transformers (BERT), or the like but is not limited to such an example. The RNN-based model is, for example, a reception weighted key value (RWKV) or the like, but is not limited to such an example.

Note that it is desirable that, by being learned not to be used as a new answer, input information conceals input information such as personal information. Furthermore, the generative AI may be a language model specially learned (for example, fine tuned) in order to generate answer information.

For example, the generative AI server 20 inputs input information received from the information processing apparatus 100 to the generative AI and provides output information output from the generative AI to the information processing apparatus 100. Note that the generative AI server 20 may be implemented by an application programming interface (API).

The content provider terminal 30 is an information processing terminal used by the content provider. For example, the content provider terminal 30 is a desktop PC, a notebook PC, a tablet terminal, a mobile phone, a PDA, or the like.

For example, the content provider terminal 30 provides, to the information processing apparatus 100, content provision information concerning content desired to be distributed. For example, the content provision information includes information in which the content provider can freely input character information concerning the content, and information concerning an image, a moving image, a banner, a flyer, and the like generated for the content by the content provider.

More specifically, it is assumed that the content is an advertisement. In this case, the content provider terminal 30 submits, to the information processing apparatus 100, advertisement information concerning an advertisement desired to be distributed. Here, the advertisement information includes submission information in which an advertiser can freely input character information concerning the advertisement and advertisement creative such as an image, a moving image, a banner, or a flier generated for advertisement by the content provider.

The settlement server 40 is an information processing apparatus that performs settlement processing and is implemented by, for example, a server apparatus or a cloud system. For example, when various types of settlement processing are executed for cost, the settlement server 40 cooperates with the information processing apparatus 100 to execute the settlement processing for the content provider.

The information processing apparatus 100 is an information processing apparatus capable of communicating with various apparatuses via the network N and is implemented by, for example, a server apparatus or a cloud system. For example, the information processing apparatus 100 is communicably connected to other various apparatuses via the network N.

Note that the information processing apparatus 100 may be an information processing apparatus that provides various services to the user terminal 10. For example, the various services are services such as Internet connection, a search service, a social networking service (SNS), electronic commerce (EC), electronic settlement, an online game, online banking, online trading, lodging/ticket reservation, video/music distribution, news, a map, a route search, route guidance, railway route information, operation information, weather forecast, and the like. More specifically, the information processing apparatus 100 may cooperate with various external servers, which provide the various services explained above, to provide the various services. The information processing apparatus 100 may cooperate with the various external servers to mediate the various services to the user.

### 3. Configuration of the Information Processing Apparatus

Next, an example of a functional configuration of the information processing apparatus 100 is explained with reference to FIG. 5. As illustrated in FIG. 5, the information processing apparatus 100 includes a communication unit 110, a storage unit 120, and a control unit 130.

### Communication Unit 110

The communication unit 110 is implemented by, for example, a network interface card (NIC). Then, the communication unit 110 is connected to the network N by wire or radio and transmits and receives information to and from other various apparatuses.

### Storage Unit 120

The storage unit 120 is implemented by, for example, a semiconductor memory element such as a random access memory (RAM) or a flash memory or a storage device such as a hard disk or an optical disk. The storage unit 120 includes a learning data storage unit 121, a first learning model 122, a content provision information storage unit 123, a user information storage unit 124, a correction value information storage unit 125, an evaluation information storage unit 126, and a second learning model 127.

### Learning Data Storage Unit 121

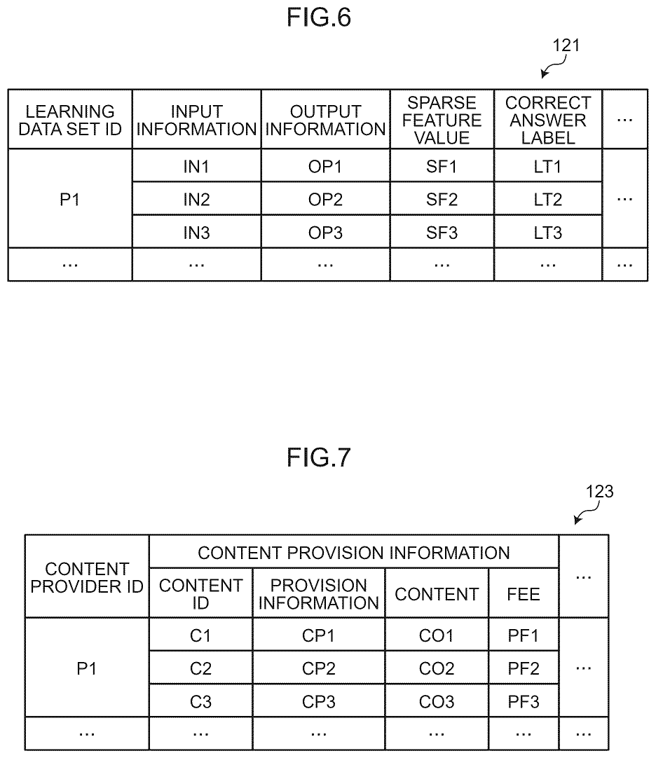

The learning data storage unit 121 stores various kinds of information concerning learning data. Here, FIG. 6 illustrates an example of the learning data storage unit 121 according to the embodiment. In the example illustrated in FIG. 6, the learning data storage unit 121 includes items such as “learning data set identifier (ID)”, “input information”, “output information”, “sparse feature value”, and “correct answer label”.

The “learning data set ID” is an identifier for identifying the learning data set. The “input information” is input information associated with the “learning data set ID”. The “output information” is output information associated with the “learning data set ID”.

The “sparse feature value” is information concerning the sparse feature value associated with the “learning data set ID”. The “correct answer label” is information concerning a correct answer label associated with the “learning data set ID”.

For example, in FIG. 6, for “P1” identified by the learning data set ID, the input information is “IN1”, the output information is “OP1”, a sparse feature value is “SF1”, and a correct answer label is “LT1”.

Note that, in the example illustrated in FIG. 6, the input information and the like are expressed by an abstract code such as “IN1”. However, the input information and the like may be, for example, in a file format of a file including various kinds of information indicating a numerical value, a character string, the input information, and the like.

### Content Provision Information Storage Unit 123

The content provision information storage unit 123 stores various kinds of information concerning content. Here, FIG. 7 illustrates an example of the content provision information storage unit 123 according to the embodiment. In the example illustrated in FIG. 7, the content provision information storage unit 123 includes items such as “content provider ID” and “content provision information”. For example, the “content provision information” includes items such as “content ID”, “provision information”, “content”, and “fee”.

The “content provider ID” is an identifier for identifying the content provider. The “content ID” is an identifier for identifying content associated with the “content provider ID”. The “provision information” is provision information provided by a content provider of the content associated with the “content ID”. For example, the provision information is character information for explaining the content, character information for appealing the content, information concerning an image or a moving image, or the like.

The “content” is information concerning the content associated with the “content ID”. The “fee” is information concerning a fee paid by the content provider when providing the content associated with the “content ID”.

For example, in FIG. 7, for “P1” identified by the content provider ID, the content ID is “C1”, the provision information is “CP1”, the content is “CO1”, and the fee is “PF1”.

Note that, in the example illustrated in FIG. 7, the provision information or the like is expressed by an abstract code such as “CP1”. However, the provision information or the like may be, for example, in a file format of a file including various kinds of information indicating a numerical value, a character string, provision information, and the like.

### User Information Storage Unit 124

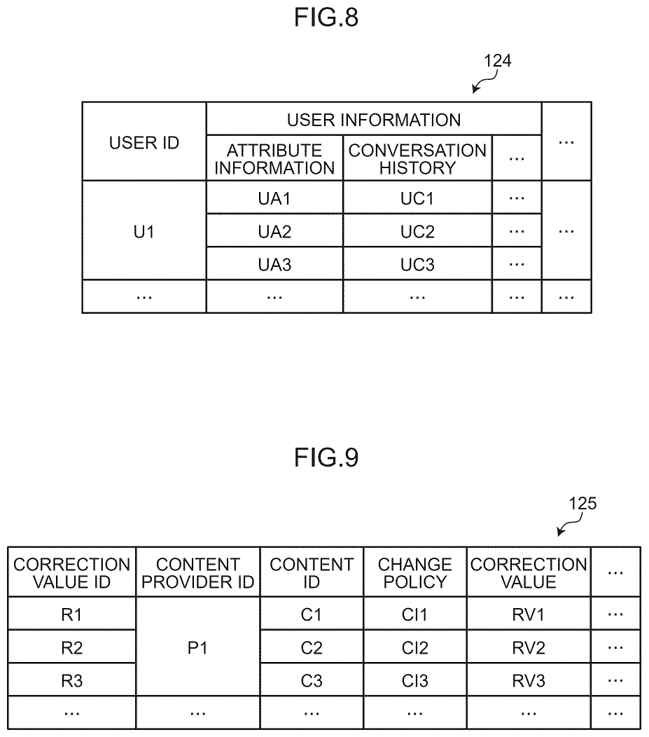

The user information storage unit 124 stores various kinds of information concerning the user. Here, FIG. 8 illustrates an example of the user information storage unit 124 according to the embodiment. In the example illustrated in FIG. 8, the user information storage unit 124 includes items such as “user ID” and “user information”. For example, the “user information” includes items such as “attribute information” and “conversation history”.

The “user ID” is an identifier for identifying the user. The “attribute information” is information concerning an attribute of the user associated with the “user ID”. For example, the attribute information is information concerning a demographic attribute, a psychographic attribute, or the like. For example, the demographic attribute is an attribute in terms of demography. More specifically, the demographic attribute includes an age, sex, an occupation, a place of residence, an annual income, a family structure, and the like. For example, the psychographic attribute is an attribute in terms of psychography. More specifically, the psychographic attributes include a lifestyle, a sense of values, and interests.

The “conversation history” is information concerning a history of input information input by the user associated with the “user ID” and output information provided by the generative AI server 20. Note that the conversation history may be information concerning a history of a conversation between the user and a chatbot provided by the generative AI server 20. In this case, in the conversation history, input information input by the user and output information corresponding to the input information and provided from the chatbot are stored in association with each other.

For example, in FIG. 8, for “U1” identified by the user ID, the attribute information is “UA1” and the conversation history is “UC1”. Note that, in the example illustrated in FIG. 8, the attribute information or the like is expressed by an abstract code such as “UA1”. However, the attribute information and the like may be, for example, in a file format of a file including various kinds of information indicating a numerical value, a character string, attribute information, and the like.

### Correction Value Information Storage Unit 125

The correction value information storage unit 125 stores various kinds of information concerning a correction value. Here, FIG. 9 illustrates an example of the correction value information storage unit 125 according to the embodiment. In the example illustrated in FIG. 9, the correction value information storage unit 125 includes items such as “correction value ID”, “content provider ID”, “content ID”, “change policy”, and “correction value”.

The “correction value ID” is an identifier for identifying a correction value. The “content provider ID” is an identifier for identifying a content provider associated with the “correction value ID”. The “content ID” is an identifier for identifying content associated with the “correction value ID”.

The “change policy” is information concerning a change policy associated with the “correction value ID”. The “correction value” is information concerning a correction value associated with the “correction value ID”.

For example, in FIG. 9, for “R1” identified by the correction value ID, the content provider ID is “P1”, the content ID is “C1”, the change policy is “CI1”, and the correction value if “RV1”.

Note that, in the example illustrated in FIG. 9, the change policy or the like is expressed by an abstract code such as “CI1”. However, the change policy or the like may be, example, in a file format of a file including a numerical value, a character string, or various kinds of information indicating the change policy or the like.

### Evaluation Information Storage Unit 126

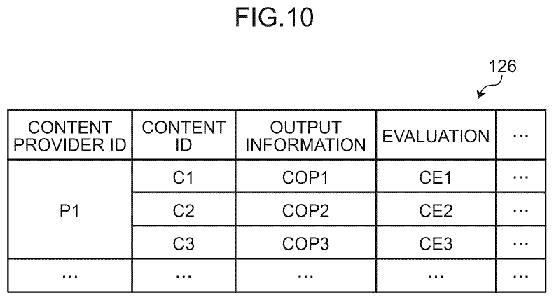

The evaluation information storage unit 126 stores various kinds of information concerning evaluation for output information. Here, FIG. 10 illustrates an example of the evaluation information storage unit 126 according to the embodiment. In the example illustrated in FIG. 10, the evaluation information storage unit 126 includes items such as “content provider ID”, “content ID”, “output information”, and “evaluation”.

The “content provider ID” is an identifier for identifying the content provider. The “content ID” is an identifier for identifying content associated with the “content provider ID”.

The “output information” is output information corresponding to the content associated with the “content ID”. The “evaluation” is information concerning evaluation of the output information corresponding to the content associated with the “content ID”. For example, the evaluation is, for example, evaluation of the content provider for the output information.

For example, in FIG. 10, for “P1” identified by the content provider ID, the content ID is “C1”, the output information is “COP1”, and the evaluation is “CE1”. Note that, in the example illustrated in FIG. 10, the output information or the like is expressed by an abstract code such as “COP 1”. However, the output information or the like may be, for example, in a file format of a file including various kinds of information indicating a numerical value, a character string, output information, and the like.

### Control Unit 130

The control unit 130 is a controller and is implemented by, for example, a central processing unit (CPU) or a micro processing unit (MPU) executing various programs (an example of an information processing program) stored in a storage device inside the information processing apparatus 100 using a RAM as a work area. The control unit 130 is a controller and is implemented by an integrated circuit such as an application specific integrated circuit (ASIC) or a field programmable gate array (FPGA).

As illustrated in FIG. 2, the control unit 130 includes a reception unit 131, an acquisition unit 132, a provision unit 133, a conversion unit 134, a learning unit 135, a change unit 136, a generation unit 137, an estimation unit 138, a determination unit 139, and a setting unit 140 and implements or executes a function and an action of information processing explained below. Note that an internal configuration of the control unit 130 is not limited to the configuration illustrated in FIG. 5 and may be another configuration if the configuration is a configuration for performing information processing explained below. A connection relationship among the processing units included in the control unit 130 is not limited to a connection relationship illustrated in FIG. 5 and may be another connection relationship.

### Reception Unit 131

The reception unit 131 receives various kinds of information. Specifically, the reception unit 131 receives input information from the user terminal 10. For example, it is assumed that the user U1 inputs character information as input information. In this case, the reception unit 131 receives the character information from the user terminal 10 as the input information. Then, the reception unit 131 stores the input information in the learning data storage unit 121.

The reception unit 131 receives output information corresponding to the input information and information concerning a feature value output by an intermediate layer of the LLM (an example of a predetermined layer in the LLM) when the input information is input. Then, the reception unit 131 stores the output information in the learning data storage unit 121.

The reception unit 131 receives information concerning evaluation for the output information from the content provider terminal 30. For example, it is assumed that the evaluation is five-grade evaluation. It is assumed that the evaluation for the output information is 5. In this case, the reception unit 131 receives information indicating that the evaluation is 5 from the content provider terminal 30 as the evaluation for the output information. Then, the reception unit 131 stores the information concerning the evaluation in the evaluation information storage unit 126. Note that the reception unit 131 may further store the evaluated output information in the evaluation information storage unit 126.

The reception unit 131 receives various requests. For example, the reception unit 131 receives information concerning a change policy provision request from the content provider terminal 30.

### Acquisition Unit 132

The acquisition unit 132 acquires various kinds of information. Specifically, the acquisition unit 132 acquires user information from the user terminal 10. Then, the acquisition unit 132 stores the user information in the user information storage unit 124.

### Provision Unit 133

The provision unit 133 provides various kinds of information. For example, the provision unit 133 provides input information to the generative AI server 20.

The provision unit 133 provides output information to the user terminal 10. For example, the provision unit 133 provides, to the user terminal 10, as the output information, output information including character information in which the reference to the automobile product of the competitor and the reference to the automobile product of the company A are included at the same ratio and the advertisement of the automobile product of the company A.

The provision unit 133 provides, to the content provider terminal 30, information concerning a change policy output by inputting information concerning a predetermined evaluation to the second learning model 127 learned by the learning unit 135.

For example, the provision unit 133 provides information concerning a change policy corresponding to the evaluation 5 as the change policy. More specifically, as the change policy corresponding to the evaluation 5, the provision unit 133 provides information concerning a change policy that the output information includes only the reference to the automobile product of the company A.

### Conversion Unit 134

The conversion unit 134 converts a feature value output by the intermediate layer into a sparse feature value. Then, the conversion unit 134 stores the sparse feature value in the learning data storage unit 121. Note that the conversion processing executed by the conversion unit 134 can be implemented by using a technique based on SAE using deep learning.

### Learning Unit 135

The learning unit 135 causes the first learning model 122 to learn a relationship among a predetermined input information input to the LLM, output information output by the LLM when the predetermined input information is input to the LLM, a sparse feature value obtained by converting a feature value output by the intermediate layer when the predetermined input information is input to the LLM, and a correct answer label attached to the sparse feature value. That is, the learning unit 135 causes the first learning model 122 to learn the learning data set stored in the learning data storage unit 121. Here, the first learning model 122 is a learning model called SAE. Then, the learning unit 135 stores the first learning model 122 in the storage unit 120.

The learning unit 135 causes the second learning model 127 to learn a relationship between the change policy and the evaluation. For example, it is assumed that the change policy in the case of generating the output information is a change policy of increasing the ratio of the reference to the automobile product of the company A in the output information when the output information includes the reference to the automobile product of the competitor. In this case, the learning unit 135 causes the second learning model 127 to learn the relationship between the change policy and the evaluation 5. As explained above, when the information concerning the predetermined evaluation is input to the second learning model 127, the learning unit 135 generates the second learning model 127 that outputs a change policy corresponding to the predetermined evaluation. Then, the learning unit 135 stores the second learning model 127 in the storage unit 120.

### Change Unit 136

The change unit 136 changes, based on a predetermined change policy, a sparse feature value that is obtained by converting a feature value output by the intermediate layer when predetermined input information is input to the LLM learned to generate, as output information, an answer to a question input as input information, the sparse feature value indicating a generation policy for the LLM to generate output information corresponding to the predetermined input information. For example, the change unit 136 changes the sparse feature value such that the generation policy is changed based on the predetermined change policy.

Here, change processing is explained with reference to FIG. 2. In the example illustrated in FIG. 2, the node UN1 indicates “0.2”. The node UN2 indicates “0.8”. The node UN3 indicates “0.6”. The node UN4 indicates “−0.2”.

Here, it is assumed that the predetermined change policy is set in advance by the company A. The predetermined change policy shall be the reference to the automobile product of the competitor. In this case, to increase the ratio of the reference to the automobile product of the company A in the output information, a value of the node UN1 corresponding to the reference is increased.

That is, the change unit 136 changes the value of the node UN1 when changing the sparse feature value based on the predetermined change policy. For example, the change unit 136 changes the sparse feature value based on a correction value based on the predetermined change policy and the sparse feature value. Accordingly, the change unit 136 changes the sparse feature value SFV1 to the sparse feature value SFV2. For example, the change unit 136 changes the sparse feature value based on the correction value. In the example illustrated in FIG. 3, the change unit 136 changes the sparse feature value SFV1 to the sparse feature value SFV2 by multiplying the sparse feature value SFV1 by Expression (1). In the sparse feature value SFV2, the node UN1 indicates “0.6”. In the sparse feature value SFV2, the node UN2 indicates “0.8”. In the sparse feature value SFV2, the node UN3 indicates “0.6”. In the sparse feature value SFV2, the node UN4 indicates “−0.2”.

As another example, the predetermined change policy shall be the reference to the automobile product of the competitor. It is assumed that the reference to the automobile product of the competitor is included in the output information. In this case, it is assumed that, to increase rates of the reference to the automobile product of the company A and reference to quality reliability of the automobile product of the company A in the output information, the values of the nodes UN1 and UN4 corresponding to the references are increased. In such a case, the change unit 136 changes the sparse feature value to increase the rates of the reference to the automobile product of the company A and the reference to the quality reliability of the automobile product of the company A in the output information.

It is assumed that the predetermined change policy reference indicating that the automobile product of the company A is easily broken. In this case, it is assumed that, if the output information includes the reference indicating that the automobile product of the company A is easily broken, to increase the rates of the reference to the automobile product of the company A and the reference to the quality reliability of the automobile product of the company A in the output information, the values of the nodes UN1 and UN4 corresponding to the references are increased. In such a case, the change unit 136 changes the sparse feature value to increase the rates of the reference to the automobile product of the company A and the reference to the quality reliability of the automobile product of the company A in the output information.

The predetermined change policy shall be the reference to the automobile product of the competitor. It is assumed that the reference to the automobile product of the competitor is included in the output information. In this case, it is assumed that, to increase the rates of the reference to the automobile product of the company A and the reference to the pleasant feeling for the automobile product of the company A in the output information, the values of the nodes UN1 and UN3 corresponding to the references are increased. In such a case, the change unit 136 changes the sparse feature value to increase the rates of the reference to the automobile product of the company A and reference to pleasant feeling for the automobile product of the company A in the output information.

As another example, the change unit 136 may change the sparse feature value based on, as the predetermined change policy, the content provision information. For example, the change unit 136 changes the sparse feature value based on, as the content provision information, the information concerning the content. More specifically, the change unit 136 may change the sparse feature value based on, as the content provision information, character information for explaining an advertisement, character information for appealing to the advertisement, information concerning an image or a moving image, or the like.

The change unit 136 may change the sparse feature value based on, as the content provision information, information concerning another appealing target different from an appealing target of the advertisement. For example, when the output information includes the automobile product of the competitor, the change unit 136 may change the sparse feature value such that only the automobile product of the company A is included in the output information.

The change unit 136 may change the sparse feature value based on, as the content provision information, information concerning a fee paid by the content provider. For example, the change unit 136 may change the sparse feature value such that an advertisement provided by a content provider that has paid the highest fee among fees paid by a plurality of content providers is included in the output information.

The change unit 136 may change the sparse feature value based on, as the predetermined change policy, the attribute information of the user stored in the user information storage unit 124. For example, it is assumed that the user is a man in his thirties. In this case, the change unit 136 may change the sparse feature value based on the attribute information such that only the automobile product of the company A is included in the output information. For example, it is assumed that interest of the user is in an automobile and is an Sport Utility Vehicle (SUV). In this case, the change unit 136 may change the sparse feature value based on the attribute information such that an automobile product of the SUV among automobile products of the company A is included in the output information.

The change unit 136 may change the sparse feature value based on, as the predetermined change policy, attribute information of the user estimated based on a history of input information input by the user. For example, it is assumed that the user is estimated to be a man in his thirties from the history of the input information of the user. In this case, the change unit 136 may change the sparse feature value based on the estimated attribute information such that only the automobile product of the company A is included in the output information. In addition, for example, it is assumed that interest of the user is in an automobile and is in an SUV. In this case, the change unit 136 may change the sparse feature value based on the estimated attribute information such that the automobile product of the SUV among the automobile products of the company A is included in the output information.

The change unit 136 may change the sparse feature value based on, as the predetermined change policy, histories of the input information input by the user and input to the LLM and the output information output by the LLM when the input information is input. For example, it is assumed that the histories of the input information and the output information include the reference to the automobile product of the company A. In this case, the change unit 136 may change the sparse feature value based on the histories of the input information and the output information such that only the automobile product of the company A is included in the output information.

### Generation Unit 137

The generation unit 137 generates various kinds of information. Specifically, the generation unit 137 causes the LLM to generate output information corresponding to the predetermined input information using, as a feature value output by the intermediate layer, a feature value obtained by converting the changed sparse feature value changed by the change unit 136. For example, the generation unit 137 generates, as the output information, character information in which the reference to the automobile product of the competitor and the reference to the automobile product of the company A are included at the same ratio. The generation unit 137 generates output information including the advertisement of the automobile product of the company A.

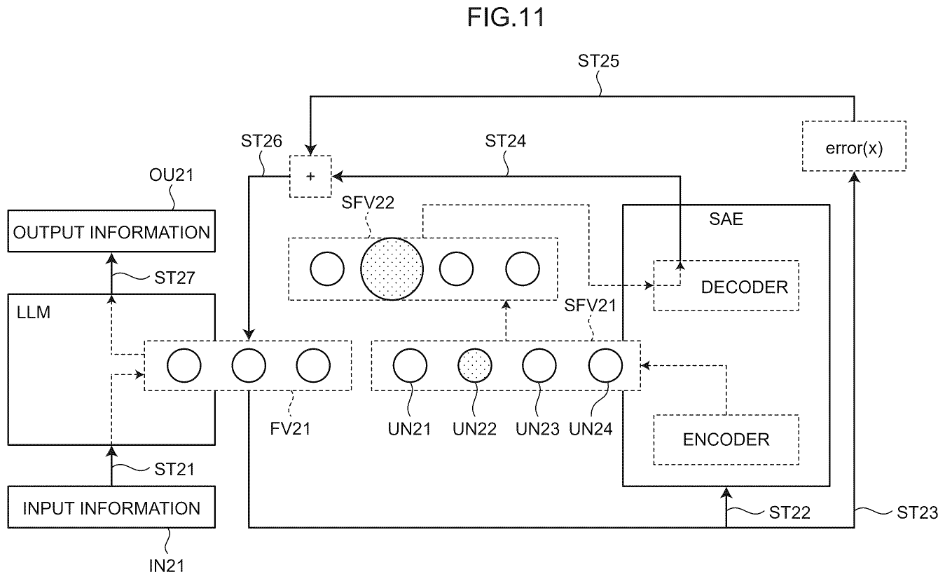

Here, a specific example of the generation processing executed by the generation unit 137 is explained with reference to FIG. 11. FIG. 11 is a conceptual diagram of generation processing according to the embodiment. In the example illustrated in FIG. 11, an example in which the LLM outputs output information OU21 when input information IN21 is input to the LLM is explained. In the example illustrated in FIG. 11, the input information IN21 is input to LLM (Step ST21). In this case, the feature value FV21 is a feature value output by the intermediate layer. For example, the feature value FV21 includes three nodes. Subsequently, the feature value FV21 is input to the SAE (corresponding to the first learning model 122) (Step ST22).

In the SAE, the feature value FV21 is input to an encoder and converted into the sparse feature value SFV21. The sparse feature value SFV21 includes four nodes UN21 to UN24. Here, it is assumed that the predetermined change policy changes a value of the node UN22 to ten times. In this case, the sparse feature value SFV21 is changed to the sparse feature value SFV22. Then, the sparse feature value SFV22 is input to a decoder and converted into a feature value.

The feature value FV21 is input to a predetermined error function error (x) (Step ST23). For example, when the feature value FV21 is input to the SAE, the predetermined error function error (x) is calculated as a reconfiguration error with the feature value FV21 input from an SAE (x) reconfigured by the SAE.

Subsequently, a feature value output from the predetermined error function error (x) (Step ST25) and a feature value converted from the sparse feature value SFV22 (Step ST24) are added up. Then, the added-up feature value causes the LLM to generate, as the feature value FV21, the output information OU21 corresponding to the input information IN21 (Steps ST26 to ST27). As explained above, the generation unit 137 causes the LLM to generate the output information OU21 corresponding to the input information IN21.

### Estimation Unit 138

Based on a sparse feature value obtained by converting a feature value output by the intermediate layer when the predetermined input information is input to the LLM learned to generate, as output information, an answer to a question input as input information, the sparse feature value indicating a generation policy for the LLM to generate output information corresponding to the predetermined input information, the estimation unit 138 estimates a change policy for the LLM to generate desired output information. Then, the estimation unit 138 stores the estimated change policy in the correction value information storage unit 125.

For example, based on the sparse feature value obtained by converting the feature value output by the intermediate layer, using the first learning model 122, the estimation unit 138 estimates output information output by the LLM. For example, it is assumed that the output information output by the LLM includes the reference to the automobile product of the competitor. In this case, the estimation unit 138 estimates, based on the sparse feature value obtained by converting the feature value output by the intermediate layer, a change policy of increasing the rate of the reference to the automobile product of the company A in the output information.

The estimation unit 138 inputs the information concerning the predetermined evaluation to the second learning model 127 to estimate a change policy for the predetermined evaluation. For example, the estimation unit 138 estimates a change policy corresponding to the evaluation 5 as the information concerning the predetermined evaluation. More specifically, the estimation unit 138 estimates, as the change policy corresponding to the evaluation 5, a change policy that the output information includes only the reference to the automobile product of the company A.

### Determination Unit 139

The determination unit 139 determines, based on the sparse feature value and the change policy, a correction value for changing the sparse feature value. Then, the determination unit 139 stores the correction value in the correction value information storage unit 125.

In the example illustrated in FIG. 3, to increase the rate of the reference to the own automobile product in the output information, the determination unit 139 determines a correction value for increasing the value of the node UN1 corresponding to the reference. For example, the determination unit 139 determines a transformation matrix such as Expression (1) as the correction value. In this case, k is, for example, 0.5.

### Setting Unit 140

The setting unit 140 sets a fee based on the correction value for the content provider. In this case, the setting unit 140 executes the settlement processing for the content provider at the fee. For example, the setting unit 140 cooperates with the settlement server 40 to execute the settlement processing for the fee for the content provider.

More specifically, the setting unit 140 executes the settlement processing for the settlement server 40 at the fee every time or in every predetermined period. Accordingly, the setting unit 140 executes the settlement processing for the content provider at the fee based on the correction value.

### 4. Processing Procedure Executed by the Information Processing Apparatus

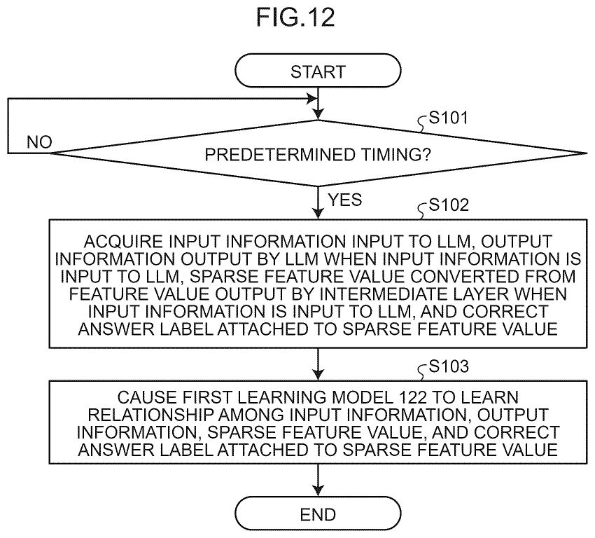

Next, flows of respective kinds of information processing executed by the information processing apparatus 100 are explained with reference to FIGS. 12 to 15.

### 4-1. Processing Procedure (1)

First, a procedure of learning processing executed by the information processing apparatus 100 according to the embodiment is explained with reference to FIG. 12. FIG. 12 is a flowchart illustrating an example of a flow of the learning processing executed by the information processing apparatus 100 according to the embodiment.

As illustrated in FIG. 12, the acquisition unit 132 determines whether predetermined timing has elapsed (Step S101). Specifically, when the predetermined timing has not elapsed (Step S101; No), the acquisition unit 132 stays on standby until the predetermined timing elapses. The predetermined timing mentioned referred to here is any timing.

On the other hand, when the predetermined timing has elapsed (Step S101; Yes), the acquisition unit 132 acquires input information input to LLM, output information output by LLM when the input information is input to LLM, a sparse feature value obtained by converting a feature value output by the intermediate layer when the input information is input to LLM, and a correct answer label attached to the sparse feature value (Step S102). Subsequently, the learning unit 135 causes the first learning model 122 to learn a relationship among the input information, the output information, the sparse feature value, and the correct answer label attached to the sparse feature value (Step S103).

### 4-2. Processing Procedure (2)

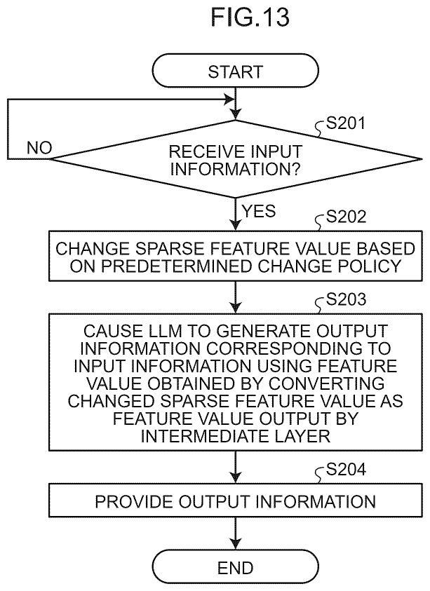

Next, a procedure of the generation processing executed by the information processing apparatus 100 according to the embodiment is explained with reference to FIG. 13. FIG. 13 is a flowchart illustrating an example of a flow of the generation processing executed by the information processing apparatus 100 according to the embodiment.

As illustrated in FIG. 13, the reception unit 131 receives input information from the user (Step S201). Specifically, when not receiving input information from the user (Step S201; No), the reception unit 131 stays on standby until input information is received from the user.

On the other hand, when the reception unit 131 receives input information from the user (Step S201; Yes), the change unit 136 changes the sparse feature value based on the predetermined change policy (Step S202).

Subsequently, the generation unit 137 causes the LLM to generate output information corresponding to the input information using, as a feature value output by the intermediate layer, a feature value obtained by converting the changed sparse feature value (Step S203). Then, the provision unit 133 provides the output information generated by the generation unit 137 to the user (Step S204).

### 4-3. Processing Procedure (3)

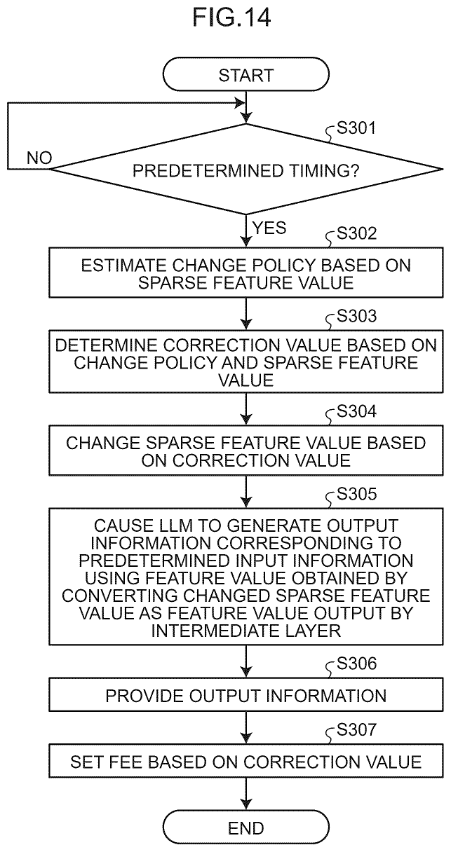

Next, a procedure of the determination processing executed by the information processing apparatus 100 according to the embodiment is explained with reference to FIG. 14. FIG. 14 is a flowchart illustrating an example of a flow of the determination processing executed by the information processing apparatus according to the embodiment.

As illustrated in FIG. 14, the estimation unit 138 determines whether predetermined timing has elapsed (Step S301). Specifically, when the predetermined timing has not elapsed (Step S301; No), the estimation unit 138 stays on standby until the predetermined timing elapses. The predetermined timing mentioned referred to here is any timing.

On the other hand, when the predetermined timing has elapsed (Step S301; Yes), the estimation unit 138 estimates a change policy based on the sparse feature value (Step S302). Subsequently, the determination unit 139 determines a correction value based on the change policy and the sparse feature value (Step S303).

Then, the change unit 136 changes the sparse feature value based on the correction value determined by the determination unit 139 (Step S304). Subsequently, the generation unit 137 causes the LLM to generate output information corresponding to the predetermined input information using a feature value obtained by converting the changed sparse feature value as a feature value output by the intermediate layer (Step S305).

Then, the provision unit 133 provides the output information generated by the generation unit 137 to the content provider (Step S306). Subsequently, the setting unit 140 sets a fee based on the correction value (Step S307).

### 4-4. Processing Procedure (4)

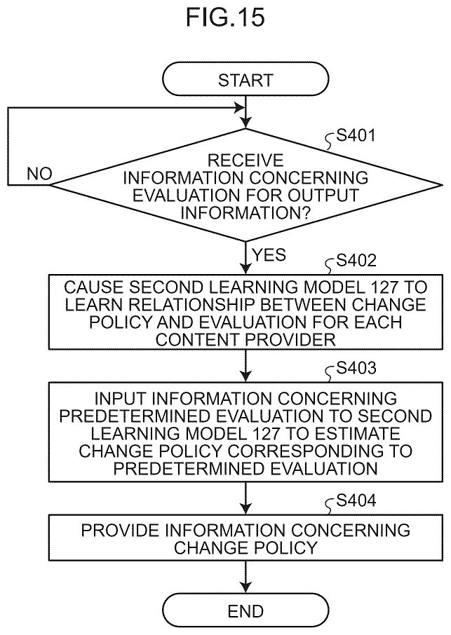

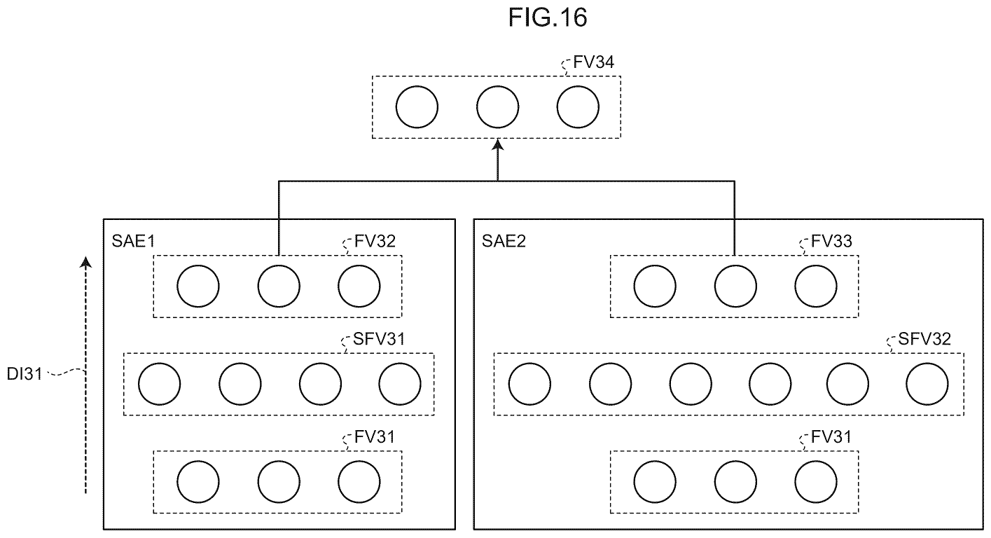

Next, a procedure of the learning processing executed by the information processing apparatus 100 according to the embodiment is explained with reference to FIG. 15. FIG. 15 is a flowchart illustrating an example of a flow of the learning processing executed by the information processing apparatus according to the embodiment.

As illustrated in FIG. 15, the reception unit 131 receives information concerning evaluation for output information from the content provider (Step S401). Specifically, when not receiving information concerning the evaluation for the output information from the content provider (Step S401; No), the reception unit 131 stays on standby until information concerning the evaluation for the output information is received from the content provider.

On the other hand, when the reception unit 131 receives information concerning the evaluation for the output information from the content provider (Step S401; Yes), the learning unit 135 causes the second learning model 127 to learn a relationship between the change policy and the evaluation for each content provider (Step S402).

Subsequently, the estimation unit 138 inputs information concerning predetermined evaluation to the second learning model 127 to estimate a change policy corresponding to the predetermined evaluation (Step S403). Then, the provision unit 133 provides information concerning the change policy estimated by the estimation unit 138 to the content provider (Step S404).

### 5. Modifications

The information processing apparatus 100 explained above may be implemented in various different forms other than the embodiment explained above. Therefore, another embodiment of the information processing apparatus 100 is explained below.

### 5-1. Content

In the embodiment explained above, the advertisement content is explained as an example of the content. However, the content is not limited to this. For example, the content may be any content.

### 5-2. Predetermined Service

In the embodiment explained above, as an example of the predetermined service, the service for providing an advertisement is explained as an example. However, the predetermined service is not limited to this. For example, the predetermined service may be any service. For example, the predetermined service may be a service for recommending content, a service for providing a guardrail function or a safety function against a fraudulent mail, or the like.

### 5-3. Content Provider

In the embodiment explained above, the content provider is explained as an example. However, instead of the content provider, for example, an administrator of a predetermined service provided by the information processing apparatus 100, the administrator managing content provided by the content provider may provide and manage content.

### 5-4. Input Information

In the embodiment explained above, an example in which the input information is the character information is explained. However, the input information is not limited to this. For example, the input information may be an image, a moving image, or the like input by the user. The input information may be, for example, voice information uttered by the user.

### 5-5. Output Information

In the embodiment explained above, an example in which the output information is the character information is explained. However, the input information is not limited to this. For example, the output information may be, for example, voice information output to the user.

### 5-6. Learning Data Set

In the embodiment explained above, an example in which the information processing apparatus 100 generates the learning data set is explained. However, the learning data set is not limited to this. For example, the information processing apparatus 100 may acquire a learning data set generated by another external server and store the learning data set in the predetermined storage unit.

### 5-7. Sparse Feature Value

In the embodiment explained above, as an example of the sparse feature value, the sparse feature value including the four nodes is explained as an example. However, the sparse feature value is not limited to this. For example, the sparse feature value may include any number of nodes. That is, the number of dimensions of the vector indicated by the sparse feature value may be any number.

The sparse feature value may include a plurality of sparse feature values. In this case, the change unit 136 changes, based on the predetermined change policy, each of the plurality of sparse feature values included in the sparse feature value.

The sparse feature value may include a plurality of sparse feature values having different numbers of dimensions of vectors. For example, the sparse feature value includes a first sparse feature value having a first number of dimensions of a vector and a second sparse feature value having a second number of dimensions of the vector. For example, it is assumed that the first number of dimensions of the vector indicated by the first sparse feature value is smaller than the second number of dimensions of the vector indicated by the second sparse feature value. In this case, the first sparse feature value includes nodes indicating an abstraction level larger than an abstraction level of a meaning indicated by one node included in the second sparse feature value.

Here, generation processing executed by the generation unit 137 when a sparse feature value includes a plurality of sparse feature values having different numbers of dimensions of vectors is explained with reference to FIG. 16. FIG. 16 is a conceptual diagram of generation processing according to a modification. In an example illustrated in FIG. 16, a direction in which learning processing is executed is a direction DI31. A feature value FV31 is a feature value output by the intermediate layer. For example, the feature value FV31 includes three nodes.

In this case, it is assumed that a plurality of SAEs are generated in advance in order to generate a plurality of sparse feature values. In the example illustrated in FIG. 16, an SAE1 and an SAE2 are generated in advance. For example, the SAE1 converts the feature value FV31 into a first sparse feature value SFV31. The SAE2 converts the feature value FV31 into a second sparse feature value SFV32. Subsequently, the SAE1 converts the first sparse feature value SFV31 into a feature value FV32. The SAE2 converts the second sparse feature value SFV32 into a feature value FV33.

Then, the generation unit 137 calculates an average value of the feature value FV32 and the feature value FV33. In this case, the generation unit 137 calculates, as an average value, a feature value FV34 indicating the average value of the feature value FV32 and the feature value FV33. Subsequently, the generation unit 137 causes the LLM to generate output information corresponding to predetermined input information using the feature value FV34 as a feature value output by the intermediate layer.

As explained above, even in the case of a plurality of sparse feature values having different numbers of dimensions of vectors, the generation unit 137 converts each of the plurality of sparse feature values into a feature value and thereafter calculates a feature value to be an average value and causes the LLM to generate output information corresponding to the predetermined input information using the calculated feature value as a feature value output by the intermediate layer. Accordingly, the generation unit 137 can generate a first learning model having high expression capability. The generation unit 137 can generate suitable output information by using the first learning model.

Change processing executed by the change unit 136 when a sparse feature value includes a plurality of sparse feature values having different numbers of dimensions of vectors is explained. For example, it is assumed that the sparse feature value includes a first sparse feature value having a first number of dimensions of a vector and a second sparse feature value having a second number of dimensions of a vector. In this case, it is assumed that a transformation matrix corresponding to the first number of dimensions of the vector indicated by the first sparse feature value is calculated in advance as a first correction value. It is assumed that a transformation matrix corresponding to the second number of dimensions of the vector indicated by the second sparse feature value is calculated in advance as a second correction value. At this time, the change unit 136 changes the first sparse feature value by multiplying the first sparse feature value by the first correction value. The change unit 136 changes the second sparse feature value by multiplying the second sparse feature value by the second correction value.

In this case, the generation unit 137 calculates an average value of a first feature value obtained by converting the first sparse feature value changed by the change unit 136 and a second feature value obtained by converting the second sparse feature value changed by the change unit 136. Then, the generation unit 137 causes the LLM to generate output information corresponding to the predetermined input information using the average value of the first feature value and the second feature value as a feature value output by the intermediate layer.

### 5-8. Evaluation

In the embodiment explained above, an example in which the reception unit 131 receives the information concerning the evaluation for the output information output by the LLM and corresponding to the predetermined input information is explained. However, the reception unit 131 is not limited to this. For example, the reception unit 131 may receive, as evaluation for the output information, information concerning evaluation for each piece of predetermined information included in the output information.

For example, it is assumed that the output information is character information. In this case, the reception unit 131 may receive information concerning evaluation for each word included in the character information. The reception unit 131 may receive information concerning evaluation for each sentence included in the character information. The reception unit 131 may receive information concerning evaluation for each clause of a sentence included in the character information. The reception unit 131 may receive information concerning evaluation for each paragraph included in the character information. As explained above, the reception unit 131 may receive information concerning evaluation for each predetermined unit.

The reception unit 131 may receive, as evaluation for the output information, information concerning evaluation for the output information from the user. For example, the reception unit 131 may receive, as evaluation from the user, information concerning a click through rate (CTR) of the user for content provided by the content provider. For example, it is assumed that content provided by the content provider is included in the output information. In this case, the reception unit 131 may receive, as evaluation from the user, information concerning the CTR of the user for the content.

The reception unit 131 may receive, as evaluation from the user, information concerning a conversion rate (CVR) of the user for content provided by the content provider. For example, it is assumed that content provided by the content provider is included in the output information. In this case, the reception unit 131 may receive, as evaluation from the user, information concerning the CVR of the user for the content. As a result, the reception unit 131 can receive information concerning not only the evaluation by the content provider but also the evaluation from the user.

### 5-9. Estimation Processing

In the embodiment explained above, an example is explained in which, based on the sparse feature value indicating the generation policy for the LLM to generate the output information corresponding to the predetermined input information, the estimation unit 138 estimates the change policy for the LLM to generate the desired output information. However, the estimation unit 138 is not limited to this. For example, the estimation unit 138 may estimate the change policy based on, as the content provision information, information concerning content. The estimation unit 138 may estimate the change policy based on, as the content provision information, information concerning another appealing target different from an appealing target of the content. The estimation unit 138 may estimate the change policy based on, as the content provision information, the information concerning the fee paid by the content provider when providing the content to the user. The estimation unit 138 may estimate the change policy based on the output information output by LLM and content provision information received from a content provider that provides predetermined content.

### 5-10. Setting Processing

In the embodiment explained above, an example in which the setting unit 140 sets the fee based on the correction value for the content provider is explained. However, the setting unit 140 is not limited to this. For example, the setting unit 140 may set, for the content provider, a fee corresponding to the number of dimensions of the vector indicated by the sparse feature value and the correction value. In this case, the setting unit 140 executes the settlement processing for the content provider at the fee. For example, the setting unit 140 cooperates with the settlement server 40 to execute the settlement processing for the fee for the content provider.

More specifically, the setting unit 140 executes the settlement processing for the settlement server 40 at the fee every time or in every predetermined period. Accordingly, the setting unit 140 executes the settlement processing for the content provider at the fee corresponding to the number of dimensions of the vector indicated by the sparse feature value and the correction value. As explained above, the setting unit 140 can execute the settlement processing for the content provider at a suitable fee.

### 5-11. Second Learning Model for Each Content Provider

In the embodiment explained above, an example in which the learning unit 135 causes the second learning model 127 to learn the relationship between the change policy and the evaluation is explained. However, the learning unit 135 is not limited to this. For example, it is assumed that information concerning evaluation is received for each content provider. In this case, the learning unit 135 causes the second learning model 127 to learn a relationship between the change policy and the evaluation for each content provider. Accordingly, the learning unit 135 can generate the second learning model 127 suitable for the content provider for each content provider.

### 5-12. Competition

Furthermore, the information processing apparatus 100 may receive information concerning a fee for the correction value from the content provider. For example, the reception unit 131 receives information concerning a first fee from a first content provider. The reception unit 131 receives information concerning a second fee from a second content provider.

Here, it is assumed that the first fee is higher than the second fee. In this case, the information processing apparatus 100 generates a sparse feature value indicating information relating to content provided from the first content provider. The information processing apparatus 100 may determine content to be included in output information as the content provided from the first content provider. As explained above, the information processing apparatus 100 may select a content provider that provides the content to be included in the output information out of a plurality of content providers based on fees received from the plurality of content providers. In this case, the information processing apparatus 100 changes the sparse feature value by multiplying a sparse feature value indicating information relating to content provided by a content provider for which a high fee is set by the transformation matrix in which the value of k indicated by Expression (1) is changed.

In such a case, the fee may be changed according to the number of dimensions of a vector indicated by the sparse feature value. For example, it is assumed that the first number of dimensions of the vector indicated by the first sparse feature value is smaller than the second number of dimensions of the vector indicated by the second sparse feature value. In this case, the first sparse feature value may be set to a fee than the fee of the second sparse feature value.

The fee may be changed according to whether one node included in the sparse feature value is a word, a sentence, a statement, or a paragraph. The fee in this case may be, for example, lower for the word than the paragraph.

The information processing apparatus 100 may receive, from the content provider, information concerning a fee generated when content is included in the output information during a predetermined period. The fee in this case is a fee corresponding to the predetermined period.

### 5-13. Program

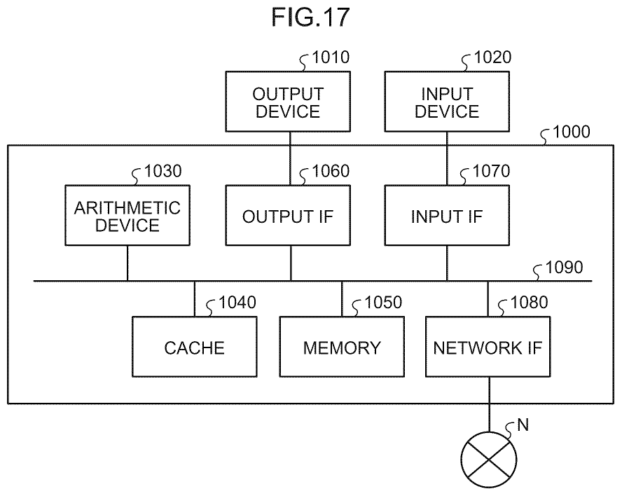

The information processing apparatus 100 according to the embodiment explained above is implemented by, for example, a computer 1000 having a configuration illustrated in FIG. 17. FIG. 17 is a diagram illustrating an example of a hardware configuration. The computer 1000 is connected to an output device 1010 and an input device 1020 and has a form in which an arithmetic device 1030, a cache 1040, a memory 1050, an output interface (IF) 1060, an input IF 1070, and a network IF 1080 are connected by a bus 1090.

The arithmetic device 1030 operates based on a program stored in the cache 1040 or the memory 1050, a program read from the input device 1020, or the like and executes various kinds of processing. The cache 1040 is a memory device such as a RAM that temporarily stores data used for various arithmetic operations by the arithmetic device 1030. The memory 1050 is a storage device in which data used for various arithmetic operations by the arithmetic device 1030 and various databases are registered and is implemented by a read only memory (ROM), a hard disk drive (HDD), a flash memory, or the like.

The output IF 1060 is an interface for transmitting output target information to the output device 1010 such as a monitor or a printer that outputs various kinds of information and is implemented by, for example, a connector of a standard such as a universal serial bus (USB), a digital visual interface (DVI), or a high definition multimedia interface (HDMI) (registered trademark). The input IF 1070 is an interface for receiving information from the input device 1020 such as a mouse, a keyboard, or a scanner and is implemented by, for example, a USB.

Note that the input device 1020 may be, for example, a device that reads information from an optical recording medium such as a compact disc (CD), a digital versatile disc (DVD), or a phase change rewritable disc (PD), a magneto-optical recording medium such as a magneto-optical disk (MO), a tape medium, a magnetic recording medium, a semiconductor memory, or the like. The input device 1020 may be an external storage medium such as a USB memory.

The network IF 1080 receives data from another equipment via the network N and transmits the data to the arithmetic device 1030 and transmits data generated by the arithmetic device 1030 to the other equipment via the network N.

The arithmetic device 1030 controls the output device 1010 and the input device 1020 via the output IF 1060 and the input IF 1070. For example, the arithmetic device 1030 loads a program from the input device 1020 or the memory 1050 onto the cache 1040 and executes the loaded program.

For example, when the computer 1000 functions as the information processing apparatus 100, the arithmetic device 1030 of the computer 1000 implements the functions of the control unit 130 by executing the program loaded on the cache 1040.

### 5-14. Others

Among the kinds of processing described in the embodiment and the modifications explained above, all or a part of the processing explained as being automatically performed can be manually performed or all or a part of the processing explained as being manually performed can be automatically performed by a publicly-known method. Besides, the processing procedures, the specific names, and the information including the various data and the parameters explained and illustrated in the above document and the drawings can be optionally changed except when specifically noted otherwise. For example, the various kinds of information illustrated in the figures are not limited to the illustrated information.

The components of the devices illustrated in the figures are functionally conceptual and are not always required to be physically configured as illustrated in the figures. That is, specific forms of distribution and integration of the devices are not limited to the illustrated form. All or a part of the devices can be functionally or physically distributed and integrated in any unit according to various loads, usage conditions, and the like.

The embodiments and the modifications explained above can be combined as appropriate within a range in which the processing contents do not contradict one another.

In addition, the “part (section, module, unit)” explained above can be replaced with “means”, “circuit”, or the like. For example, the generation unit can be replaced with generation means or a generation circuit.

### 6. Effects

As explained above, the information processing apparatus 100 according to the embodiment includes the change unit 136 and the generation unit 137. The change unit 136 changes, based on the predetermined change policy, the sparse feature value obtained by converting the feature value output by the predetermined layer of the learning model when the predetermined input information is input to the learning model learned to generate, as the output information, an answer to a question input as the input information, the sparse feature value indicating the generation policy for the learning model to generate the output information corresponding to the predetermined input information. The generation unit 137 causes the learning model to generate the output information corresponding to the predetermined input information using, as the feature value output by the predetermined layer in the learning model, the feature value obtained by converting the changed sparse feature value changed by the change unit 136.

The information processing apparatus 100 according to the embodiment can generate suitable output information based on a predetermined change policy.

In the information processing apparatus 100 according to the embodiment, the change unit 136 changes, based on the predetermined change policy, the sparse feature value such that the generation policy is changed.

Accordingly, the information processing apparatus 100 according to the embodiment can suitably change the sparse feature value based on the predetermined change policy.

In the information processing apparatus 100 according to the embodiment, the change unit 136 changes the sparse feature value based on the correction value based on the predetermined change policy and the sparse feature value.

Accordingly, the information processing apparatus 100 according to the embodiment can suitably change the sparse feature value based on the predetermined change policy.

Furthermore, in the information processing apparatus 100 according to the embodiment, the change unit 136 changes, based on the predetermined change policy, the sparse feature value indicating the information relating to the content provided by the predetermined service.

Accordingly, the information processing apparatus 100 according to the embodiment can suitably change, based on the predetermined change policy, the sparse feature value indicating the information relating to the content provided by the predetermined service.

In the information processing apparatus 100 according to the embodiment, the change unit 136 changes, based on the predetermined change policy, the sparse feature value in which one dimension among the dimensions of the vector indicated by the sparse feature value indicates the information relating to the content provided by a predetermined service.

Accordingly, the information processing apparatus 100 according to the embodiment can suitably change, based on the predetermined change policy, the sparse feature value in which one dimension among the dimensions of the vector indicated by the sparse feature value indicates the information relating to the content provided by the predetermined service.

In the information processing apparatus 100 according to the embodiment, the change unit 136 changes, based on a predetermined change policy, the sparse feature value indicating the appealing target of the content.

As a result, the information processing apparatus 100 according to the embodiment can suitably change, based on the predetermined change policy, the sparse feature value indicating the appealing target of the content.

Furthermore, in the information processing apparatus 100 according to the embodiment the change unit 136 changes the sparse feature value based on, as the predetermined change policy, the content provision information received from the content provider that provides content in the predetermined service.

Accordingly, the information processing apparatus 100 according to the embodiment can suitably change the sparse feature value based on the content provision information.

In the information processing apparatus 100 according to the embodiment, the change unit 136 changes the sparse feature value based on, as the content provision information, the information concerning the content.

Accordingly, the information processing apparatus 100 according to the embodiment can suitably change the sparse feature value based on the information concerning the content.

In the information processing apparatus 100 according to the embodiment, the change unit 136 changes the sparse feature value based on, as the content provision information, the information concerning another appealing target different from the appealing target of the content.

Accordingly, the information processing apparatus 100 according to the embodiment can suitably change the sparse feature value based on the information concerning the other appealing target.

In the information processing apparatus 100 according to the embodiment, the change unit 136 changes the sparse feature value based on, as the content provision information, the information concerning the fee paid by the content provider when providing the content to the user.

Accordingly, the information processing apparatus 100 according to the embodiment can suitably change the sparse feature value based on the information concerning the fee.

In the information processing apparatus 100 according to the embodiment, the change unit 136 changes the sparse feature value based on, as the predetermined change policy, the change policy set by the content provider that provides content in the predetermined service.

Accordingly, the information processing apparatus 100 according to the embodiment can suitably change the sparse feature value based on the change policy set by the content provider.

In the information processing apparatus 100 according to the embodiment, the change unit 136 changes the sparse feature value based on, as the predetermined change policy, the attribute information of the user acquired from the user.

Accordingly, the information processing apparatus 100 according to the embodiment can suitably change the sparse feature value based on the attribute information of the user.

In the information processing apparatus 100 according to the embodiment, the change unit 136 changes, the sparse feature value based on, as the predetermined change policy, the attribute information of the user estimated based on the history of the input information input by the user.

Accordingly, the information processing apparatus 100 according to the embodiment can suitably change the sparse feature value based on the attribute information of the user estimated based on the history of the input information.

In the information processing apparatus 100 according to the embodiment, the change unit 136 changes the sparse feature value based on, as the predetermined change policy, the history of the input information input by the user and input to the learning model and the output information output by the learning model when the input information is input.

Accordingly, the information processing apparatus 100 according to the embodiment can suitably change the sparse feature value based on the histories of the input information and the output information.

The information processing apparatus 100 according to the embodiment further includes the learning unit 135 that causes another learning model different from the learning model to learn the relationship among the predetermined input information input to the learning model, the output information output by the learning model when the predetermined input information is input to the learning model, the sparse feature value obtained by converting the feature value output by the predetermined layer when the predetermined input information is input to the learning model, and the correct answer label attached to the sparse feature value.

As explained above, the information processing apparatus 100 according to the embodiment can cause the learning model to suitably learn various kinds of learning data. Accordingly, the information processing apparatus 100 can generate a suitable learning model.

According to an aspect of an embodiment, there is an effect that it is possible to generate suitable output information based on a predetermined change policy.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a change unit configured to change, based on a predetermined change policy, a sparse feature value obtained by converting a feature value output by a predetermined layer in a learning model when predetermined input information is input to the learning model learned to generate, as output information, an answer to a question input as input information, the sparse feature value indicating a generation policy for the learning model to generate output information corresponding to the predetermined input information; and
a generation unit configured to cause the learning model to generate output information corresponding to the predetermined input information using a feature value obtained by converting the changed sparse feature value changed by the change unit as a feature value output by the predetermined layer in the learning model.

2. The information processing apparatus according to claim 1, wherein
the change unit changes the sparse feature value such that the generation policy is changed based on the predetermined change policy.

3. The information processing apparatus according to claim 1, wherein
the change unit changes the sparse feature value based on a correction value based on the predetermined change policy and the sparse feature value.

4. The information processing apparatus according to claim 1, wherein the change unit changes, based on the predetermined change policy, the sparse feature value indicating information relating to content provided by a predetermined service.

5. The information processing apparatus according to claim 4, wherein
the change unit changes, based on the predetermined change policy, the sparse feature value in which one dimension of dimensions of a vector indicated by the sparse feature value indicates information relating to content provided by the predetermined service.

6. The information processing apparatus according to claim 4, wherein
the change unit changes, based on the predetermined change policy, the sparse feature value indicating an appealing target of the content.

7. The information processing apparatus according to claim 1, wherein
the change unit changes the sparse feature value based on, as the predetermined change policy, content provision information received from a content provider that provides content in a predetermined service.

8. The information processing apparatus according to claim 7, wherein
the change unit changes the sparse feature value based on, as the content provision information, information concerning the content.

9. The information processing apparatus according to claim 7, wherein
the change unit changes the sparse feature value based on, as the content provision information, information concerning another appealing target different from the appealing target of the content.

10. The information processing apparatus according to claim 7, wherein
the change unit changes the sparse feature value based on, as the content provision information, information concerning a fee paid by the content provider when providing the content to a user.

11. The information processing apparatus according to claim 1, wherein
the change unit changes the sparse feature value based on, as the predetermined change policy, a change policy set by a content provider that provides content in a predetermined service.

12. The information processing apparatus according to claim 1, wherein
the change unit changes the sparse feature value based on, as the predetermined change policy, attribute information of a user acquired from the user.

13. The information processing apparatus according to claim 12, wherein
the change unit changes the sparse feature value based on, as the predetermined change policy, attribute information of the user estimated based on a history of input information input by the user.

14. The information processing apparatus according to claim 1, wherein
the change unit changes the sparse feature value based on, as the predetermined change policy, histories of input information input by a user and input to the learning model and output information output by the learning model when the input information is input.

15. The information processing apparatus according to claim 1, further comprising
a learning unit configured to cause another learning model different from the learning model to learn a relationship among the predetermined input information input to the learning model, output information output by the learning model when the predetermined input information is input to the learning model, a sparse feature value obtained by converting a feature value output by the predetermined layer when the predetermined input information is input to the learning model, and a correct answer label attached to the sparse feature value.

16. An information processing method executed by a computer, the information processing method comprising:
a change step of changing, based on a predetermined change policy, a sparse feature value obtained by converting a feature value output by a predetermined layer in a learning model when predetermined input information is input to the learning model learned to generate, as output information, an answer to a question input as input information, the sparse feature value indicating a generation policy for the learning model to generate output information corresponding to the predetermined input information; and
a generation step of causing the learning model to generate output information corresponding to the predetermined input information using a feature value obtained by converting the changed sparse feature value changed by the change step as a feature value output by the predetermined layer in the learning model.

17. A non-transitory computer-readable recording medium having stored therein an information processing program for causing a computer to execute:
a change procedure of changing, based on a predetermined change policy, a sparse feature value obtained by converting a feature value output by a predetermined layer in a learning model when predetermined input information is input to the learning model learned to generate, as output information, an answer to a question input as input information, the sparse feature value indicating a generation policy for the learning model to generate output information corresponding to the predetermined input information; and
a generation procedure of causing the learning model to generate output information corresponding to the predetermined input information using a feature value obtained by converting the changed sparse feature value changed by the change procedure as a feature value output by the predetermined layer in the learning model.
